(19) United States
(12) Patent Application Publication
(10) Pub. No.: US 2023/0280227 A1
(43) Pub. Date: Sep. 7, 2023

(54) WATERPROOF PRESSURE SENSOR DEVICE WITH IMPROVED TEMPERATURE CALIBRATION AND CORRESPONDING TEMPERATURE CALIBRATION METHOD

(71) Applicant: STMICROELECTRONICS S.r.l., Agrate Brianza (IT)

(72) Inventors: Enri DUQI, Milan (IT); Filippo DANIELE, Milan (IT); Lorenzo BALDO, Bareggio (IT); Giulio CAPELLI, Milano (IT); Salvatore ALONGI, Milano (IT)

(73) Assignee: STMICROELECTRONICS S.r.l., Agrate Brianza (IT)

(21) Appl. No.: 18/171,184

(22) Filed: Feb. 17, 2023

(30) Foreign Application Priority Data
Mar. 1, 2022 (IT) 102022000003824

(51) Int. Cl. G01L 19/04; G01L 9/00; G01L 19/00

(52) U.S. Cl. CPC G01L 19/04; G01L 9/0041; G01L 19/0092

(57) ABSTRACT

A pressure sensor device is provided with: a pressure detection structure made in a first die of semiconductor material; a package, configured to internally accommodate the pressure detection structure in an impermeable manner, the package having a base structure and a body structure, arranged on the base structure, with an access opening in contact with an external environment and internally defining a housing cavity, in which the first die is arranged covered with a coating material. The pressure sensor device is also provided with a heating structure, accommodated in the housing cavity and for allowing heating of the pressure detection structure from the inside of the package.

### BACKGROUND

### Technical Field

The present disclosure relates to a waterproof pressure sensor device with improved temperature calibration and a temperature calibration method.

### Description of the Related Art

Water-resistant or impermeable (so-called “waterproof”) microelectromechanical (MEMS—Micro Electro Mechanical System) pressure sensor devices are known.

These pressure sensor devices may for example be used in portable or wearable electronic apparatuses, such as smartphones, smartbands or smartwatches, which may be used for underwater applications or in general in-water.

The aforementioned pressure sensor devices typically comprise a detection structure provided with a membrane suspended above a cavity and wherein detection elements (for example piezoresistors) are provided, to detect the deformation caused by impinging pressure waves.

This detection structure is integrated within a package, usually together with corresponding signal reading and processing electronics, provided as an ASIC (Application Specific Integrated Circuit), which provides at an output a pressure signal, indicative of the detected pressure.

The aforementioned package has an inlet opening, to allow the detection of the external pressure, and internally defines a housing cavity wherein the aforementioned detection structure and the associated ASIC are accommodated.

Typically, this housing cavity is filled with a protective coating, such as a coating gel (so-called “potting gel”), for example of polymeric or silicone type, which coats and protects the detection structure and the ASIC from humidity and in general from contaminants coming from outside of the package. Only this protective material is in contact with the external environment, effectively making the housing cavity (filled with the same protective material) impermeable or hermetic.

In a known manner, electrical test procedures of a pressure sensor device, in particular at the end of a corresponding manufacturing process, include carrying out a plurality of pressure measurements at different temperature values, to calibrate the response of the same pressure sensor device as the temperature varies (for example in order to adapt, as a function of the temperature, the pressure signal provided at the output during subsequent normal operation).

These test procedures typically envisage use of an external test equipment, provided with measurement probes and configured to adjust the temperature of a test chamber wherein the pressure sensor device is arranged, to vary the temperature thereof and acquire corresponding calibration pressure signals. For example, the pressure signal at the output of the pressure sensor device may be acquired at the following different calibration temperature values (or set points): 10° C., 42.5° C. and 70° C.

A suitable temperature sensor may be integrated in the pressure sensor device, in order to implement a feedback control of the temperature reached by the same pressure sensor device during the calibration phase.

A problem affecting this test procedure is related to the fact that the aforementioned protective coating within the package of the pressure sensor device is thermally insulating, due to the reduced thermal conductivity of the material of which it is made.

Consequently, during the aforementioned test procedure, long waiting times are generally needed to reach the desired calibration temperature values; in particular, these waiting times may even be in the order of tens of seconds.

By way of example, FIG. 1 shows the test temperature trend during a calibration procedure, considering a plurality of different pressure sensor devices subject to electrical testing.

This FIG. 1 shows the ramps required for the temperature to stabilize around the calibration values; in the example, these ramps (indicated with “Ramp1,” “Ramp2,” and “Ramp3”) have the following average durations, considering the pressure sensor devices tested: about 30 s for the ramp from 25° C. to 10° C. (Ramp1); about 50 s for the ramp from 10° C. to 42.5° C. (Ramp2); and about 30 s for the ramp from 42.5° C. to 70° C. (Ramp3).

In particular, time delays mainly occur in proximity of the calibration values, when the reduction of the thermal gradient between the measurement chamber and the inside of the pressure sensor device determines a reduction in the heat transfer rate and consequent waiting times for reaching the calibration values.

These waiting times generally entail a considerable overall duration of the electrical procedures for testing of the pressure sensor devices.

Moreover, the circuitry required in the external test equipment for controlling and adjusting the calibration temperature for the pressure sensor device is rather complex.

### BRIEF SUMMARY

The present disclosure is, in general, directed to overcome the previously highlighted drawbacks of the known solutions.

According to the present disclosure, a pressure sensor device and a corresponding calibration method are therefore provided.

At least one embodiment of a pressure sensor device of the present disclosure may be summarized as including a pressure detection structure provided in a first die of semiconductor material; a package, configured to internally accommodate said pressure detection structure in an impermeable manner, said package including a base structure and a body structure, arranged on the base structure, having an access opening in contact with an external environment and internally defining a housing cavity, in which said first die is arranged covered with a coating material, further including, accommodated in said housing cavity, a heating structure, configured to allow heating of said pressure detection structure from the inside of said package.

### BRIEF DESCRIPTION OF THE SEVERAL VIEWS OF THE DRAWINGS

For a better understanding of the present disclosure, embodiments thereof are now described, purely by way of non-limiting example and with reference to the attached drawings, wherein:

FIG. 1 shows an exemplary trend of a calibration temperature during an electrical test procedure of pressure sensor devices;

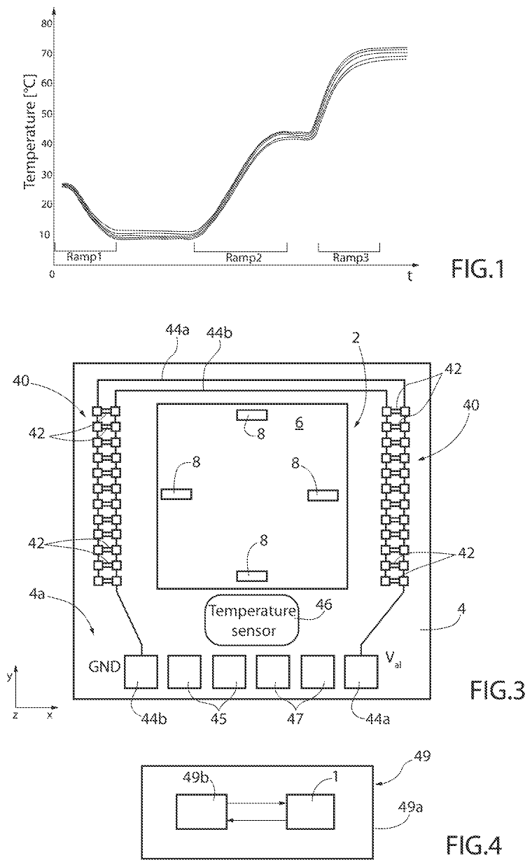

FIG. 2 illustrates a schematic cross-section of a pressure sensor device, according to an embodiment of the present disclosure;

FIG. 3 illustrates a schematic plan view of a pressure detection structure of the pressure sensor device of FIG. 2, with an associated heating structure;

FIG. 4 is a schematic block diagram of a test system for the pressure sensor device; and FIGS. 5 and 6 are flowcharts of electrical test procedures for the pressure sensor device.

### DETAILED DESCRIPTION

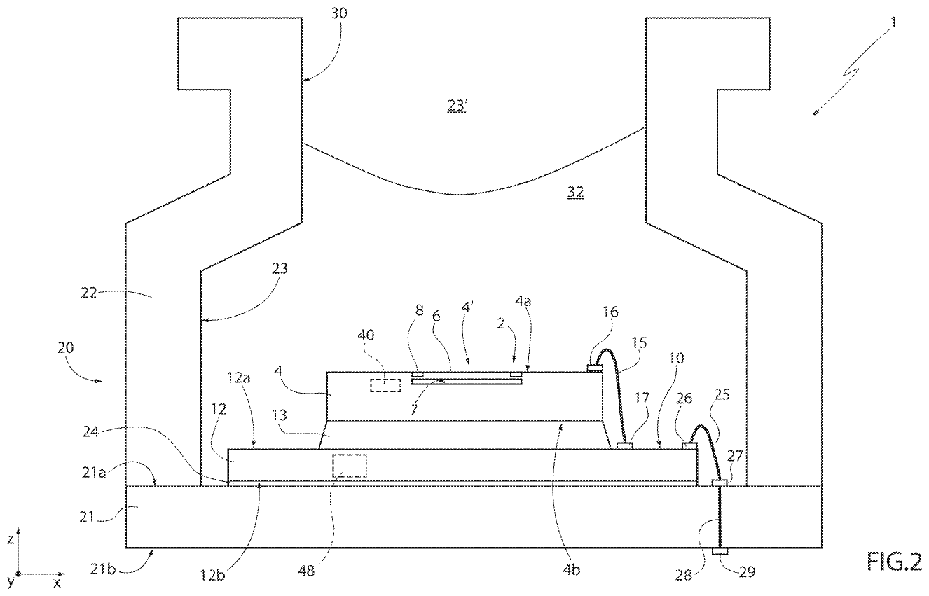

FIG. 2 shows a pressure sensor device 1, comprising a pressure detection structure 2 provided in a first die 4 of semiconductor material, in particular silicon.

The first die 4 has a top or first surface 4a and a bottom or second surface 4b, with extension parallel to a horizontal plane xy and opposite to each other along a vertical axis z, orthogonal to the aforementioned horizontal plane xy.

The pressure detection structure 2 comprises a membrane 6, provided at the top surface 4a, arranged above a cavity 7, buried within the die 4; in other words, the membrane 6 is interposed between the underlying cavity 7 and the aforementioned top surface 4a of the first die 4. Detection elements 8, in particular piezoresistors, are arranged in the membrane 6 and are configured to allow detection of deformations of the membrane 6 due to impinging pressure waves.

The pressure sensor device 1 further comprises a processing circuit 10, implemented as an ASIC, integrated in a second die 12 of semiconductor material, in particular silicon, having a respective top or first surface 12a and a respective bottom or second surface 12b. In the illustrated embodiment, the aforementioned first and second dies 4, 12 are arranged stacked, with the top surface 12a of the second die 12 coupled, by a first bonding region 13 to the bottom surface 4b of the first die 4.

First bonding wires 15 electrically connect first pads 16 carried by the top surface 4a of the first die 4 to respective second pads 17 carried by the top surface 12a of the second die 12, to allow the electrical connection between the pressure detection structure 2 (and the corresponding detection elements 8) and the processing circuit 10.

In particular, the processing circuit 10 is configured to generate, as a function of electrical signals supplied by the detection elements 8, an output pressure signal, indicative of the pressure impinging on the membrane 6.

The pressure sensor device 1 also comprises a waterproof package 20, configured to internally accommodate the aforementioned stack formed by the pressure detection structure 2 and the associated processing circuit 10 in an impermeable or hermetic manner.

This package 20 comprises a base structure 21 and a body structure 22, arranged on the base structure 21 and having a cup shape and internally defining a housing cavity 23, in which the pressure detection structure 2 and the processing circuit 10 are arranged.

The bottom surface 12b of the second die 12 is coupled, by a second bonding region 24, to an internal surface 21a of the base structure 21, facing the aforementioned housing cavity 23.

Second bonding wires 25 electrically connect third pads 26 carried by the top surface 12a of the second die 12, to respective fourth pads 27 carried by the internal surface 21a of the base structure 21, to allow the electrical connection between the processing circuit 10 and the outside of the package 20.

To this end, electrically conductive through vias 28 traverse the entire thickness of the base structure 21 and connect the aforementioned fourth pads 27 to external connection elements 29, for example provided in the form of respective pads (as in the illustrated example) or of conductive bumps, carried by an external surface 21b of the same base structure 21, placed in contact with the external environment.

In a manner not illustrated, these external connection elements 29 may be contacted, from the outside of the package 20, for example by a control unit of an electronic apparatus wherein the pressure sensor device 1 is incorporated, or, as will be discussed in detail hereinbelow, by an electrical testing equipment.

The aforementioned body structure 22 has upwardly (at one end opposite to the base structure 21) an access opening 30, for allowing introduction within the package 20 of the pressure waves to be detected.

A protective coating 32 fills almost entirely the aforementioned housing cavity 23 and entirely covers and coats the aforementioned stack formed by the pressure detection structure 2 and the associated processing circuit 10, to ensure its protection from water (or in general from contaminants coming from the external environment); this protective coating 32 is in particular a coating gel (potting gel), for example a polymeric or silicone gel.

According to an aspect of the present disclosure, the pressure sensor device 1 further comprises, integrated in the same first die 4, a heating structure 40 (shown schematically in FIG. 2), configured to allow heating of the pressure detection structure 2, internally to the package 20 of the same pressure sensor device 1.

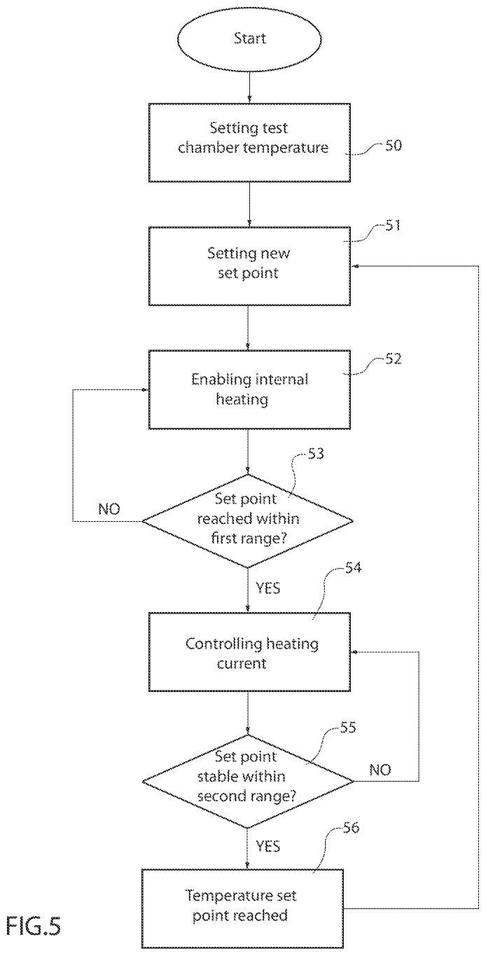

In detail and with reference also to FIG. 3 (which shows, by way of example, the aforementioned membrane 6 with a cross-shaped arrangement of four detection elements 8), this heating structure 40 comprises a plurality of resistive elements 42, arranged in proximity of the membrane 6, at the top surface 4a of the first die 4.

Such resistive elements 42 are for example made by respective regions of polysilicon (or other suitable material) formed on the top surface 4a of the first die 4, laterally and externally with respect to the membrane 6.

In the example shown, the membrane 6 is substantially square-shaped in the horizontal plane xy and the aforementioned resistive elements 42 are arranged in two groups, aligned respectively to a first and a second side, opposite to each other, of the same membrane 6.

These resistive elements 42 are electrically parallel-connected to each other by a first and a second conductive track 43a, 43b, also provided on the same top surface 4a of the first die 4. In particular, the first conductive track 43a connects first ends of the aforementioned resistive elements 42 to each other and to a first pad 44a formed on the aforementioned top surface 4a; and the second conductive track 43b connects second ends of the aforementioned resistive elements 42 to each other and to a second pad 44b.

During operation, the first pad 44a is for example set to a supply potential (Vₐₗ) and the second pad 44b is set to a reference potential (ground, GND), such that a heating current flows through the aforementioned resistive elements 42, causing heating thereof and, consequently, causing a variation in the temperature of the adjacent pressure detection structure 2.

Advantageously, the parallel connection of the resistive elements 42 allows a low resistance to the flow of the aforementioned heating current to be obtained, so to reduce the electrical consumption associated with the aforementioned heating.

For example, in the illustrated embodiment, the aforementioned heating structure 40 comprises twenty-four resistive elements 42 parallel-connected to each other, each provided with a polysilicon region having a width equal to 6 μm and a length equal to 21 μm, to form an overall resistance having the value of 104Ω (considering a resistivity for the polysilicon equal to 725 Ω/sq).

The pressure sensor device 1 moreover comprises further pads 45, which are electrically connected (in a manner not illustrated) to the detection elements 8 arranged in the membrane 6, to allow detection of deformations of the same membrane 6.

Furthermore, the pressure sensor device 1 comprises at least one temperature sensor 46 (schematically shown in the same FIG. 3), also integrated in the first die 4, in the example in proximity to the membrane 6, for allowing detection of the temperature of the pressure detection structure 2. To this end, the aforementioned temperature sensor 46 is electrically connected (in a manner not illustrated) to respective pads 47, also formed on the top surface 4a of the first die 4.

In a manner not illustrated in detail, respective first bonding wires 15 may electrically connect the first and the second pads 44a, 44b and the further pads 45 and 47 to the processing circuit 10 integrated in the second die 12.

In a possible embodiment, as schematically shown in the aforementioned FIG. 2, this processing circuit 10 may comprise a temperature adjustment module 48, integrated in the second die 12 and configured to control the supply of the aforementioned heating current to the heating structure 40, on the basis of a feedback control of the temperature reached by the pressure detection structure 2, detected through the aforementioned temperature sensor 46, in particular during a test and temperature calibration procedure of the pressure sensor device 1.

In an alternative embodiment (here not illustrated), bonding wires may connect the aforementioned first and second pads 44a, 44b directly to respective fourth pads 27 carried by the internal surface 21a of the base structure 21, to allow the electrical connection towards the outside of the package 20. In this case, the adjustment of the temperature of the pressure detection structure 2 through the aforementioned heating structure 40 may be entrusted to an electronic equipment external to the pressure sensor device 1.

Tests carried out by the present Applicant have shown a high response speed by the heating structure 40, for example with the possibility of raising the temperature of the pressure detection structure 2 from 20° C. to 50° C. in just 150 ms, for a resulting heating rate of 200° C./s (instead of a heating rate of 4° C./s obtainable by heating the pressure sensor device 1 from the outside by the external testing equipment).

The aforementioned heating structure 40 may therefore be operated to cause heating of the pressure detection structure 2 from the inside of the package 20 of the pressure sensor device 1, during an electrical test and temperature calibration procedure of the pressure sensor device 1.

In particular, the aforementioned heating structure 40 may cause such heating in an exclusive manner (i.e., without any intervention by an external testing equipment), or in cooperation with this external testing equipment.

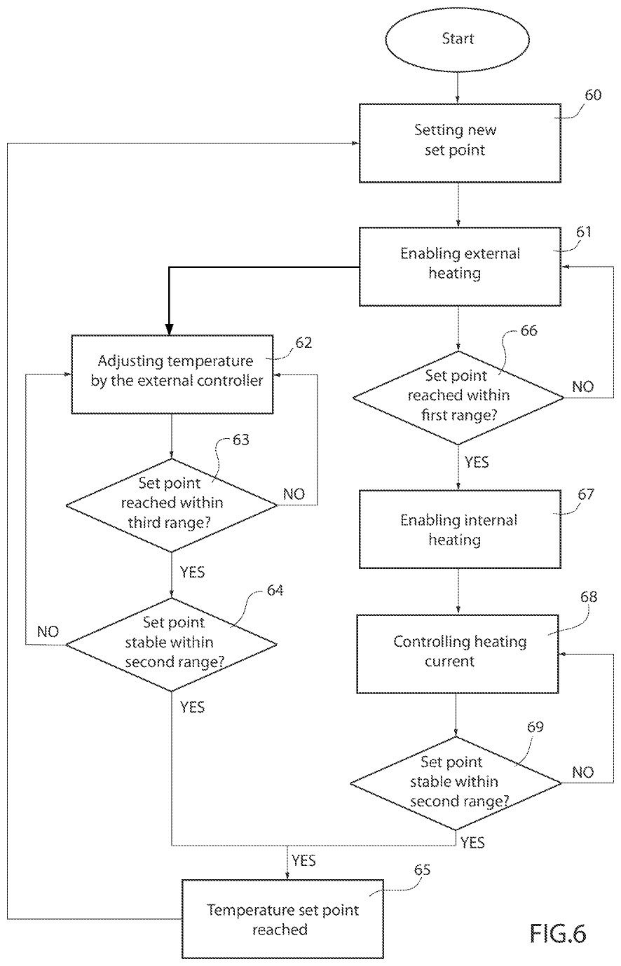

In this regard, FIG. 4 schematically shows an electrical test system 49, comprising a test chamber 49a and a testing equipment 49b, arranged in the test chamber 49a and configured to perform test and calibration procedures of the pressure sensor device 1, in particular to acquire pressure signals at different calibration temperature values.

With reference to FIG. 5, a first test and temperature calibration procedure is now described, wherein the adjustment of the temperature of the pressure sensor device 1 is entrusted in an exclusive manner to the sole heating structure 40 (i.e., without the intervention of the aforementioned testing equipment 49b being required).

In detail, in an initial step 50, the temperature of the aforementioned test chamber 49a wherein the pressure sensor device 1 is accommodated during the test procedure is set to a temperature lower than a first calibration temperature value, for example a temperature equal to 5° C.

Subsequently, at step 51, a new temperature set point is iteratively established for the calibration of the pressure sensor device 1 (in particular, the first temperature set point, in the case of a first iteration of the procedure, is for example equal to 10° C.).

Then, at step 52, the internal heating of the same pressure sensor device 1 is implemented, by enabling the corresponding heating structure 40 with the supply of the heating current.

Then, at step 53, it is verified whether the established temperature set point has been reached within a first temperature range, for example ±5° C. around the aforementioned set point (note that this verification may be implemented on the basis of the information provided by the temperature sensor 46 internal to the same pressure sensor device 1).

In case the verification is positive, at step 54, a feedback control of the heating current supplied to the heating structure 40 is implemented, for example by the aforementioned temperature adjustment module 48 internal to the processing circuit 10, in order to reach a stable temperature of the same heating structure 40.

In particular, at step 55, it is verified that the established temperature set point is stable within a second temperature range, lower with respect to the aforementioned first temperature range, for example of ±0.2° C. around the established set point.

In case the verification is positive, at step 56, it is determined that the set point has been reached and, for example, the acquisition and storage of a corresponding calibration value for the pressure signal provided at the output of the pressure sensor device 1 is implemented.

Then, the procedure may proceed iteratively (returning to the aforementioned step 51) with the setting of a new temperature set point, for example having a value higher than the previous one, until the calibration of the pressure sensor device 1 ends.

As an alternative to what has been illustrated, heating of the pressure detection structure 2 may be implemented in conjunction and in cooperation by the aforementioned heating structure 40 internal to the pressure sensor device 1 and by the testing equipment 49b external to the same pressure sensor device 1.

With reference to FIG. 6, in this case, in an initial step 60 the new temperature set point is established iteratively for the calibration of the pressure sensor device 1 (in particular, the first temperature set point, in the case of a first iteration of the procedure).

Then, at step 61, the testing equipment 49b is operated to heat from the outside, by heat conduction, the pressure detection structure 2 of the pressure sensor device 1.

In particular, as shown in step 62, a controller of this testing equipment 49b (for example a PID—Proportional Integral Derivative—controller) adjusts the heating/cooling of the pressure sensor device 1 (for example, using the information provided as a feedback by the temperature sensor 46 internal to the same pressure sensor device 1).

Then, at step 63, a verification is made by the same controller whether the established temperature set point has been reached within a third temperature range, for example of ±0.5° C. around the aforementioned set point (note that this third temperature range is intermediate between the aforementioned first and second temperature ranges).

Following a positive verification, the same controller proceeds to a new verification, at step 64, to verify that the temperature is stable within the aforementioned second temperature range, for example of ±0.2° C., around the established set point.

In case the verification is positive, at step 65, it is determined that the set point has been reached and the calibration procedure is implemented, for example by acquiring and storing a corresponding value for the pressure signal provided at the output of the pressure sensor device 1.

In this case, in parallel to the temperature adjustment action implemented by the testing equipment 49b, as soon as it is verified, at step 66, that the established temperature set point has been reached within the aforementioned first temperature range, for example of ±5° C., the internal heating of the same pressure sensor device 1 is also enabled, at step 67, by enabling the corresponding heating structure 40 with the supply of the heating current.

Note that this internal heating therefore operates in conjunction with the heating from the outside implemented by testing equipment 49b, thus speeding up reaching of the established temperature set point.

In particular, as shown in step 68, the feedback control of the heating current supplied to the heating structure 40 is implemented, for example by the aforementioned temperature adjustment module 48 internal to the processing circuit 10, in order to reach the stable temperature of the same heating structure 40.

As soon as it is verified, at step 69, that the temperature is stable within the second temperature range around the established set point, it is determined that the set point has been reached and the acquisition of the calibration signal is implemented (as previously described at step 65).

The procedure may then proceed iteratively with the establishment of a new temperature set point (at step 60), for example having a value higher than the previous one, until the calibration of the pressure sensor device 1 ends.

The advantages that the present disclosure affords are clear from the preceding description.

In any case, it is highlighted that integration of the heating structure 40 within the pressure sensor device 1 allows a considerable reduction of the times required by the electrical test procedure of the same pressure sensor device 1 and also a reduction of the complexity of the testing equipment 49b.

The presence of this heating structure 40 allows the temperature of each pressure sensor device 1 to be finely adjusted, possibly also during its normal operation (even outside the aforementioned electrical test procedure).

Finally, variations and modifications may be applied to the present disclosure and embodiments of the present disclosure.

In particular, it is highlighted that the number and arrangement of the resistive elements 42 of the aforementioned heating structure 40 may vary with respect to what has been previously illustrated by way of example. For example, these resistive elements 42 may be arranged around the entire perimeter of the membrane 6 of the pressure detection structure 2 in the horizontal plane xy, or be arranged side by side to only one or even more of the sides of the same membrane 6. The same resistive elements 42 may also be made with a material other than polysilicon.

Moreover, it is again highlighted that controlling and adjusting the temperature of the pressure detection structure 2 by the heating structure 40 may be implemented internally to the processing circuit 10 of the pressure sensor device 1 (in the aforementioned temperature adjustment module 48) or, alternatively, by an electronics external to the same pressure sensor device 1 (for example by the aforementioned testing equipment 49b).

Finally, it is noted that the pressure sensor device 1 may have various fields of use, for example for industrial or automotive applications, in general in any application wherein hermetic pressure detection is required.

At least one embodiment of a pressure sensor device (1) of the present disclosure may be summarized as including a pressure detection structure (2) provided in a first die (4) of semiconductor material; a package (20), configured to internally accommodate said pressure detection structure (2) in an impermeable manner, said package (20) including a base structure (21) and a body structure (22), arranged on the base structure (21), having an access opening (30) in contact with an external environment and internally defining a housing cavity (23), in which said first die (4) is arranged covered with a coating material (32), further including, accommodated in said housing cavity (23), a heating structure (40), configured to allow heating of said pressure detection structure (2) from the inside of said package (20).

Said heating structure (40) may be integrated in said first die (4).

Said heating structure (40) may include a plurality of resistive elements (42), arranged at a top surface (4a) of the first die (4), parallel-connected to each other for being traversed by a heating electric current to implement the heating of said pressure detection structure (2).

Said pressure detection structure (2) may include a membrane (6), provided at the top surface (4a) of said first die (4), arranged above a respective cavity (7), buried within the first die (4); and detection elements (8), of a piezoresistive type, arranged in said membrane (6) and configured to allow detection of deformations of the membrane (6) due to impinging pressure waves; wherein said resistive elements (42) of said heating structure (40) may be arranged externally to, and in proximity of, said membrane (6).

Said resistive elements (42) may be made by respective polysilicon regions formed on the top surface (4a) of said first die (4), laterally and externally with respect to said membrane (6).

The device may further include a processing circuit (10), implemented as an ASIC (Application Specific Integrated Circuit), integrated in a second die (12) of semiconductor material, accommodated in said housing cavity (23) of said package (20); said processing circuit (10) may include a temperature adjustment module (48), integrated in the second die (12) and configured to control supply of the heating current to the heating structure (40).

The device may further include a temperature sensor (46), integrated in the first die (4), for allowing detection of the temperature of the pressure detection structure (2); wherein said temperature adjustment module (48) may be configured to control the supply of the heating current to the heating structure (40) on the basis of a feedback control of the temperature of the pressure detection structure (2), detected through said temperature sensor (46), during a test and temperature calibration procedure of the pressure sensor device (1).

Said first and second dies (4, 12) may be arranged stacked, with a top surface (12a) of the second die (12) coupled, by a bonding region (13), to the bottom surface (4b) of the first die (4).

Said heating structure (40) may be configured to implement heating of said pressure detection structure (2) from the inside of said package (20) during an electrical test procedure of the pressure sensor device (1) wherein output signals from said pressure detection structure (2) are acquired at different temperature reference values.

An electrical testing system (49), may be configured to acquire, at different temperature reference values, output signals from the pressure detection structure (2) of the pressure sensor device (1).

The system may include a testing equipment (49b), configured to adjust the temperature of said pressure detection structure (2) from outside of said package (20), in cooperation and in conjunction with said heating structure (40).

At least one embodiment of an electrical test method of a pressure sensor device (1) of the present disclosure may be summarized as including a pressure detection structure (2) made in a first die (4) of semiconductor material; a package (20), configured to internally accommodate said pressure detection structure (2) in an impermeable manner, said package (20) including a base structure (21) and a body structure (22), arranged on the base structure (21), having an access opening (30) in contact with an external environment and internally defining a housing cavity (23), in which said first die (4) is arranged covered with a coating material (32), said method including adjusting the temperature of said pressure detection structure (2) from inside of said package (20) by a heating structure (40) accommodated in said housing cavity (23).

The method may include acquiring output signals from the pressure detection structure (2) of the pressure sensor device (1) at different temperature reference values.

The method may include adjusting the temperature of said pressure detection structure (2) from outside of said package (20) through an external testing equipment (49b), in cooperation and in conjunction with the heating from the inside of said package (20) by said heating structure (40).

The method may include enabling a temperature adjustment through said external testing equipment (49b); and subsequently enabling said heating structure (40) when the temperature of said pressure detection structure (2) is in a first range around a desired temperature reference value.

The method may include implementing a feedback control of the heating current supplied to the heating structure (40), in order to reach a stable temperature of the same heating structure (40) within a second temperature range around the reference value, said second range being smaller than said first range.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a first die including:
a pressure detection structure including a membrane and a detection element within the membrane; and
a heating structure;
a package contains the first die, the package including a base structure and a body structure on the base structure, the package having an access opening in fluid communication with an external environment and internally defining a housing cavity, in which the first die is arranged and in which the first die is covered with a coating material,
wherein heating structure is configured to heat the pressure detection structure from an inside of the package.

2. The device according to claim 1, wherein the first die further includes:
a first portion at which the piezoelectric transduction structure is integrated; and
a second portion separate and distinct from the first portion at which the heating structure is integrated.

3. The device according to claim 2, wherein the heating structure includes a plurality of resistive elements at a first surface of the first die, the plurality of resistive elements are parallel-connected to each other for being traversed by a heating electric current to implement the heating of the pressure detection structure.

4. The device according to claim 3, wherein the pressure detection structure includes a membrane provided at the surface of the first die, arranged over a cavity buried within the first die; and
wherein the detection element is of a piezoresistive type and is configured to detect deformations of the membrane due to impinging pressure waves, and
wherein the plurality of resistive elements of the heating structure are arranged adjacent to and in proximity of the membrane.

5. The device according to claim 3, wherein the plurality of resistive elements include respective polysilicon regions at the first surface of the first die, and the plurality of resistive elements are lateral to the membrane.

6. The device according to claim 3, further comprising a second die including a processing circuit, implemented as an ASIC (Application Specific Integrated Circuit), the second die being in the housing cavity of the package, and the processing circuit including a temperature adjustment module configured to control supply of the heating current to the heating structure.

7. The device according to claim 6, wherein:
the first die further includes a temperature sensor configured to detect a temperature of the pressure detection structure, and
the temperature adjustment module is configured to control the supply of the heating current to the heating structure based on a feedback control of the temperature of the pressure detection structure detected by the temperature sensor during a test and temperature calibration procedure.

8. The device according to claim 6, wherein the first and second dies are stacked, and a second surface of the second die is coupled to the first surface of the first die by a bonding region.

9. The device according to claim 1, wherein the heating structure is configured to implement heating of the pressure detection structure from the inside of the package during an electrical test procedure, and wherein output signals from the pressure detection structure are acquired at different temperature reference values.

10. A method, comprising:
testing a pressure sensor device, the pressure sensor device including:
a first die including:
a pressure detection structure; and
a heating structure;
a package contains the first die, the package including a base structure and a body structure on the base structure, the body structure having an access opening in contact with an external environment and internally defining a housing cavity, in which said first die is arranged covered with a coating material,
wherein testing the pressure sensor device including:
adjusting a temperature of the pressure detection structure from inside of the package by the heating structure accommodated in the housing cavity.

11. The method according to claim 10, further comprising acquiring output signals from the pressure detection structure of the pressure sensor device at different temperature reference values.

12. The method according to claim 10, further comprising adjusting the temperature of the pressure detection structure from an outside of the package through external testing equipment in cooperation and in conjunction with the heating from the inside of the package by the heating structure.

13. The method according to claim 12, further comprising:
enabling a temperature adjustment through the external testing equipment; and
subsequently enabling the heating structure when the temperature of the pressure detection structure is in a first range around a temperature reference value.

14. The method according to claim 13, further comprising implementing a feedback control of a heating current supplied to the heating structure to reach a stable temperature within a second temperature range around the temperature reference value, the second range being smaller than the first range.

15. A system, comprising:
a pressure sensor device including:
a base structure including a surface;
a body structure on the surface of the base structure, the body structure including a housing cavity and an access opening in fluid communication with the housing cavity, the access opening exposing the housing cavity to an environment external to the pressure sensor device;
a first die on the surface or the base structure and within the housing cavity; and
a second die within the housing cavity and on the first die, the second die including:
a pressure detection structure;
a heating structure configured to generate heat within the housing cavity; and
a temperature sensor;
an external testing equipment including a testing chamber that contains the pressure sensor device, the external testing equipment configured to externally heat the pressure sensor device by generating heat within the testing chamber in which the pressure sensor is contained.

16. The system of claim 15, wherein:
the pressure sensor detection structure of the first die includes a membrane, the membrane having a first side and an second side opposite to the first side;
the pressure sensor device further includes a plurality of resistive elements, and
the plurality of resistive elements including a first group on the first side of the membrane and a second group on the second side of the membrane;
the membrane is between the first group of the plurality of resistive elements and the second group of the plurality of the resistive elements.

17. The system of claim 15, wherein the pressure sensor device further includes a plurality of resistive elements, and the plurality of resistive elements are parallel-connected to each other.

18. The system of claim 15, wherein the pressure sensor device further includes a coating material in the housing cavity, the coating material encases the first die and the second die.

19. The system of claim 15, wherein the external testing equipment and the heating structure are configured to heat an exterior of the pressure sensor device and an interior pressures sensor device at the same time.

20. The system of claim 19, wherein the external testing equipment heats is configured to heat the pressure sensor device to a temperature within a first range of temperature detected by the temperature sensor within the pressure sensor device, and, after the temperature is within the first temperature range, the heating structure is configured to be activated to heat an interior of the pressure sensor device.
